(19) United States
(12) Patent Application Publication
(10) Pub. No.: US 2017/0316366 A1
(43) Pub. Date: Nov. 2, 2017

(54) BURIED ASSET LOCATOR RETROFIT CARD FOR MOTION SENSING FOR QUALITY CONTROL

(71) Applicant: IPEG CORPORATION, Naples, FL (US)

(72) Inventor: Alan Haddy, Naples, FL (US)

(21) Appl. No.: 15/617,566

(22) Filed: Jun. 8, 2017

Related U.S. Application Data
(63) Continuation-in-part of application No. 15/215,331, filed on Jul. 20, 2016.
Application No. 15/215,331 is a continuation of application No. 15/144,423, filed on May 2, 2016.

(51) Int. Cl. G06Q 10/06

(52) U.S. Cl. CPC G06Q 10/06398; G06Q 10/06395

(57) ABSTRACT

A printed circuit card assembly (PCBA) and a system configured for retrofitting a conventional electromagnetic locator device (ELD) with quality control and quality assurance processes is provided. The PCBA includes a printed circuit board (PCB) including electrical components, an orifice configured for fastening to the ELD, a communications bus, a power network for distributing power, a data and power connector for coupling to the ELD, a global navigation satellite system (GNSS) processor, a low-power radio frequency (RF) transmitter/receiver, and a processor for reading from the conventional ELD raw data as a result of performance of a buried asset location procedure by a field technician, determining a performance measurement that corresponds with the raw data, and wirelessly transmitting the performance measurement that was calculated.

### CROSS-REFERENCE TO RELATED APPLICATIONS

This patent application is a continuation in part of patent application Ser. No. 15/215,331 filed Jul. 20, 2016 and titled “Buried Asset Locate Device Motion Sensing for Quality Control,” which is a continuation in part of patent application Ser. No. 15/144,423 filed May 2, 2016 and titled “Measuring Locate Technician Performance for Quality Assurance.” The subject matter of patent application Ser. Nos. 15/215,331 and 15/144,423 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to the detection and identification of buried assets (i.e., underground utility lines) and, more specifically, to retrofitting cable locators for quality control and quality assurance.

### BACKGROUND

Utility lines, such as lines for telephones, electricity distribution, natural gas, cable television, fiber optics, Internet, traffic lights, street lights, storm drains, water mains, and wastewater pipes, are often located underground. Said utility lines described above are referred to as “buried assets” herein. Consequently, before excavation occurs in an area, especially an urban area, an excavator is typically required to clear excavation activities with the proper authorities and service providers. The clearance procedure usually requires that the excavator contact a central authority (such as “One Call”, “811” and “Call Before You Dig,” which are well known in the art) which, in turn, sends a notification to the appropriate utility companies. Subsequently, each utility company must perform a buried asset detection procedure, which includes having a field technician visit the proposed excavation site, detecting the relevant buried assets and physically marking the position of the buried asset using temporary paint or flags.

Usually, a field technician visiting a proposed excavation site utilizes a portable electronic device known as a pipe or cable locator, an electromagnetic locate device (“ELD”), an electromagnetic locator, a buried asset locate device, or a buried asset locator (collectively referred to herein as an “ELD”). Said ELDs are commercial, off-the-shelf, devices employed to detect and identify the position of buried assets. ELDs are usually used in conjunction with a transmitter, so as to create a field that can be detected by the ELD. This is typically achieved by connecting the transmitter to a suitable connection point (i.e., pedestal, hydrant, manhole, removable cover, lid, junction box or other access point) of the buried asset, wherein the transmitter sends a signal of a specific frequency onto the buried asset. Subsequently, the ELD is “tuned” to the specific frequency in order to locate the resulting electromagnetic signal radiating from the buried asset, thus enabling the position and route of the buried asset to be marked with paint or flags above surface. Best practice standards require the operator perform very specific and consistent physical motions with the ELD such as sweeping, rotating and lifting, all while the ELD must be orientated correctly to the plane of the buried asset to ensure correct geometric alignment with the radiated electromagnetic field. The process of detecting and marking out a buried asset using an ELD is referred to herein as a buried asset locate procedure, buried asset location procedure, or a buried asset detection procedure.

The aforementioned buried asset location procedure, however, takes time and training to master. There are a variety of techniques that the field technician must learn in order to perform buried asset location procedures in a way that meets best practice standards. Often, the field technician may spend a significant amount of time at a training facility learning proper techniques and then perform an apprenticeship afterwards. After completing the aforementioned training and apprenticeship, field technicians then commence work performing buried asset location procedure.

Once field technicians begin work performing buried asset location procedures, however, there is little data that managers and administrators can view to determine the performance of a field technician, the quality of the buried asset location procedure or the data collected by him Managers may have access to some buried asset data (i.e., global navigation satellite system, or GNSS, points) collected by field technicians, but this data only tells part of the story. Some companies have even used geo-locational data to measure how much the field technician has travelled in a given day or during a given project. But again, this data only reveals one aspect of a field technician's productivity. As such, there is an unknown, or blackout, period during a typical field technician's work day when managers or administrators have no data against which to evaluate the field technician's performance, any errors in technique and the quality of operations. Consequently, there is currently no way for a manager or administrator to get a complete picture of a field technician's performance, or the quality of operations, during a buried asset locate procedure.

This problem is compounded by the fact that, technologically, conventional ELDs have not developed much in the last 30 years. As a result, the technology within most conventional ELDs on the market and in the field is, for the most part, antiquated. Consequently, conventional ELDs do not currently have the hardware available to detect, store and disseminate data about buried asset locate procedures, much less the quality of the same. Further, conventional ELDs are very costly, and there are a large number of already existing conventional ELDs on the market and in the field. These facts make it financially unfeasible for said conventional ELDs to simply be replaced all at once. Additionally, the development of an entirely new platform for ELDs would require training for the existing corps of field technicians, which can be costly and time consuming.

Therefore, a need exists for improvements over the prior art, and more particularly for more efficient methods and systems for measuring the performance of field technicians during a buried asset locate procedure, using conventional ELDs.

### SUMMARY

A printed circuit card assembly (PCBA) and a system configured for retrofitting a conventional ELD with quality control and quality assurance processes is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a printed circuit card assembly (PCBA) configured for retrofitting a conventional electromagnetic locator device (ELD) with quality control and quality assurance processes is disclosed. The PCBA includes a printed circuit board (PCB) including a plurality of electrical components, at least one orifice in the PCB configured for fastening to the conventional ELD, a first communications bus for transferring data, a first power network for distributing power, a data and power connector configured for: 1) communicatively coupling the first communications bus with a communications bus on the conventional ELD, and 2) conductively coupling the first power network with a power network on the conventional ELD, a global navigation satellite system (GNSS) processor communicatively coupled with the first communications bus and conductively coupled with the first power network, the GNSS processor configured for calculating a current global position, a low-power radio frequency (RF) transmitter/receiver communicatively coupled with the first communications bus and conductively coupled with the first power network, the RF transmitter/receiver configured for transmitting and receiving data over RF, a processor communicatively coupled with the first communications bus and conductively coupled with the first power network, the processor configured for: a) storing a lookup table that defines a correspondence between each one of a plurality of component values and one of a plurality of performance measurements of a buried asset location procedure performed by a field technician, b) reading from the conventional ELD via the data and power connector, in real time, the following raw data produced by the conventional ELD as a result of performance of a buried asset location procedure by a first field technician: motion data from an accelerometer and a gyroscope in the conventional ELD, wherein said motion data is produced as a result of movement of the conventional ELD by the field technician during performance of the buried asset location procedure, electromagnetic data from one or more electromagnetic sensors in the conventional ELD, wherein said electromagnetic data is produced as a result of movement of the conventional ELD by the field technician during performance of the buried asset location procedure, and an operating mode of the conventional ELD, wherein the operating mode is set by the field technician during performance of the buried asset location procedure, c) calculating component values of a performance record based on the raw data produced by the conventional ELD as a result of performance of the buried asset location procedure by the first field technician and populating the performance record with said component values, d) accessing the lookup table, and reading a performance measurement that corresponds with each one of said plurality of component values of the performance record, so as to read a plurality of performance measurements, and e) transmitting, via the RF transmitter/receiver, the performance record that was calculated and the performance measurement that corresponds with each one of said plurality of component values of the performance record.

### BRIEF DESCRIPTION OF THE DRAWINGS

The accompanying drawings, which are incorporated in and constitute a part of this disclosure, illustrate various example embodiments. In the drawings:

FIG. 1A is a diagram of an operating environment that supports a method and system for measuring quality of a buried asset location procedure for quality control and quality assurance, according to an example embodiment;

FIG. 1B is an illustration of a conventional ELD in a disassembled state, showing the PCBA being installed for retrofitting the conventional ELD, according to an example embodiment;

FIG. 1C is an illustration of the PCBA for retrofitting the conventional ELD, showing the internal components of the PCBA, according to an example embodiment;

FIG. 2 is a diagram showing the data flow of the general process for measuring quality of a buried asset location procedure for quality control and quality assurance, according to an example embodiment;

FIG. 3 is a flow chart showing the control flow of the process for measuring quality of a buried asset location procedure for quality control and quality assurance, according to an example embodiment;

FIG. 4 is an illustration showing the process of logging buried asset data points, according to an example embodiment;

FIG. 5 is an illustration showing movement of the ELD in various degrees of freedom, according to an example embodiment;

FIG. 6 is a block diagram of a system including a computing device, according to an example embodiment.

### DETAILED DESCRIPTION

The following detailed description refers to the accompanying drawings. Wherever possible, the same reference numbers are used in the drawings and the following description to refer to the same or similar elements. While embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The claimed subject matter improves over the prior art by providing way of retrofitting the large number of antiquated, and expensive, conventional ELDs on the market and in the field, to include quality control and quality assurance processes. Retrofitting already existing conventional ELDs does not require replacing existing ELDs and does not require additional training for the existing corps of field technicians. This makes it financially feasible to include quality control and quality assurance processes in conventional ELDs.

The claimed subject matter also provides a more efficient, automated and precise way of measuring the performance of a field technician, using a conventional ELD, during a buried asset locate procedure for quality control and quality assurance purposes. The example embodiments log a variety of data collected by an ELD during a buried asset locate procedure and then determines the performance of the field technician, based on said collected data. The example embodiments leverage the vast amount of data that can be collected during a buried asset locate procedure to assess and quantify a field technician's performance, as compared to industry standards for buried asset locate procedures and techniques. The disclosed embodiments reduce or eliminate the unknown, or blackout, period during a field technician's work day when managers or administrators have no data against which to evaluate a field technician's performance. Hence, the example embodiments provide a complete picture of a field technician's performance during a buried asset locate procedure, which may be used for quality control and quality assurance purposes.

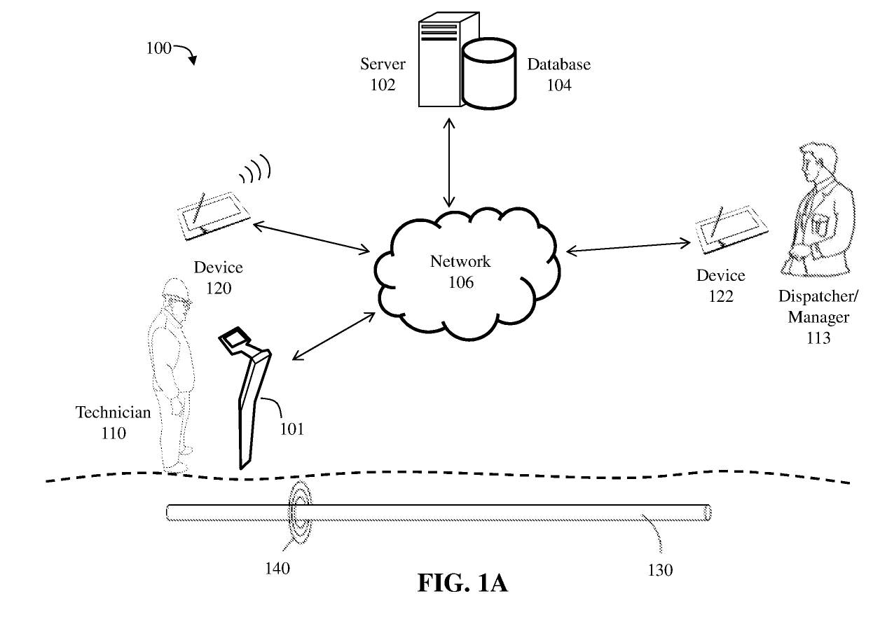

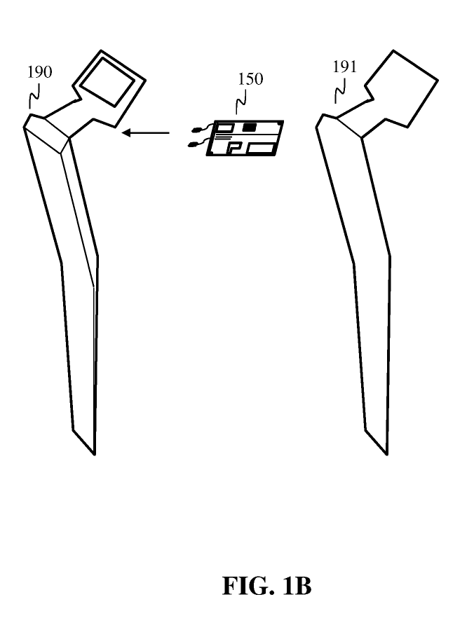

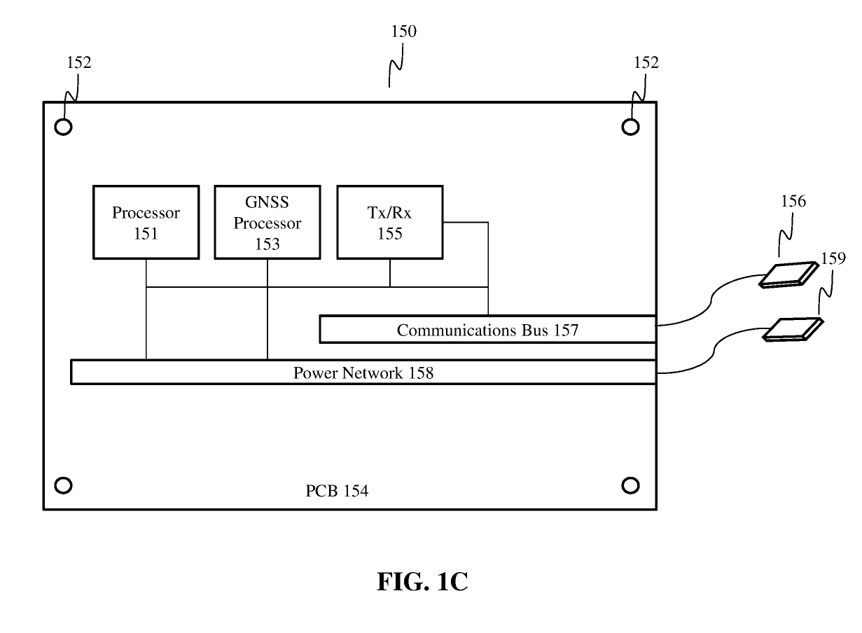

FIG. 1A is a diagram of an operating environment 100 that supports a method and system for measuring quality of a buried asset location procedure for quality control and quality assurance. The server or computing device 102 may be communicatively coupled with a communications network 106, according to an example embodiment. The environment 100 may comprise mobile computing devices 120, 122, which may communicate with computing device 102 via a communications network 106. Mobile computing devices 120, 122 may comprise a cellular/mobile telephone, smart phone, tablet computer, laptop computer, handheld computer, wearable computer, or the like. Devices 120, 122 may also comprise other computing devices such as desktop computers, workstations, servers, and game consoles, for example. The mobile computing devices 120, 122 may be connected either wirelessly or in a wired or fiber optic form to the communications network 106. Communications network 106 may be a packet switched network, such as the Internet, or any local area network, wide area network, enterprise private network, cellular network, phone network, mobile communications network, or any combination of the above.

FIG. 1 also shows an electromagnetic locator device (“ELD”) 101, retrofitted as explained herein, which detects and measures radio frequency and/or electromagnetic signals 140 emanating from a buried asset 130, and which performs quality control and quality assurance processes. In one embodiment, ELD 101 includes all of the functions of a conventional ELD, which is well known in the art. ELD 101 is also connected either wirelessly or in a wired or fiber optic form to the communications network 106. ELD 101 may comprise a computing device 600. In one embodiment, a conventional ELD is defined as a handheld cable locator well known in the art, wherein the cable locator includes a series of antennas that take electromagnetic readings emanating from a buried asset, and wherein the cable locator processes said readings, and then displays information about said readings on a display for a technician to view.

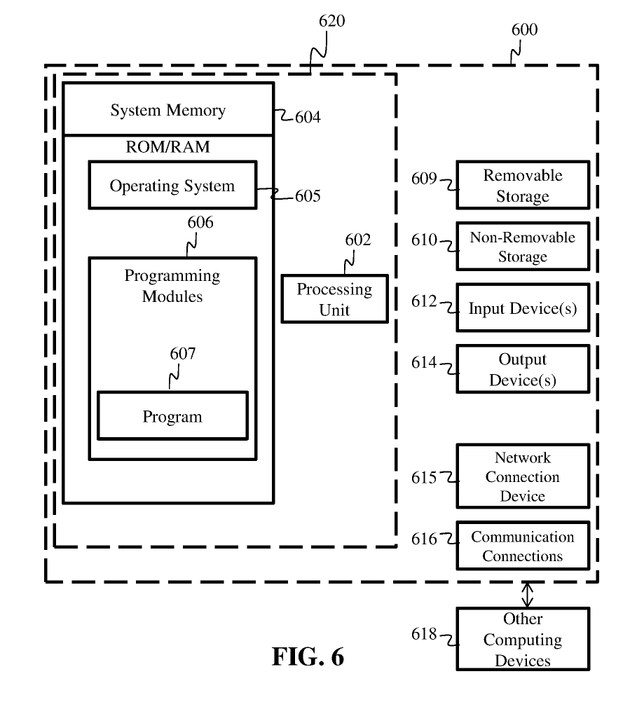

The environment 100 shows that mobile computing device 120 is operated by a technician or operator 110 (i.e., a field technician). Device 122 may also be operated by a manager or a dispatcher 113 that dispatches or provides support to a technician 110 (alternatively, the technician 110 may be the same person as manager 113). Server 102, ELD 101 and devices 120, 122 may each comprise a computing device 600, described below in greater detail with respect to FIG. 6.

In another embodiment, the devices 120, 122 also calculate current geographical position (otherwise referred to as geographical location data) using an on-board processor or a connected processor. In one embodiment, the devices 120, 122 may calculate current position using a satellite or ground based positioning system, such as a Global Positioning System (GPS) system, which is a navigation device that receives satellite or land based signals for the purpose of determining the device's current geographical position on Earth. Generally, devices 120, 122 calculate global navigation satellite system (GNSS) data. A GNSS or GPS receiver, and its accompanying processor, may calculate latitude, longitude and altitude information. In this document, the terms GNSS and GPS are used generally to refer to any global navigation satellite system, such as GLONASS, GALILEO, GPS, etc. In this embodiment, a radio frequency signal is received from a satellite or ground based transmitter comprising a time the signal was transmitted and a position of the transmitter. Subsequently, the devices 120, 122 calculate current geographical location data of the device based on the signal. In another embodiment, the devices 120, 122 calculate current geographical location using alternative services, such as control plan locating, GSM localization, dead reckoning, or any combination of the aforementioned position services. The term spatial technologies or spatial processes refers generally to any processes and systems for determining one's position using radio signals received from various sources, including satellite sources, land-based sources and the like.

Computing device 102 includes a software engine that delivers applications, data, program code and other information to networked devices, such as 120, 122. The software engine of device 102 may perform other processes such as transferring multimedia data in a stream of packets that are interpreted and rendered by a software application as the packets arrive. FIG. 1 further shows that device 102 includes a database or repository 104, which may be a relational database comprising a Structured Query Language (SQL) database stored in a SQL server. Mobile computing devices 120, 122 may also include their own database, either locally or via the cloud. The database 104 may serve buried asset data, buffer zone data, portable transmitter hookup data, as well as related information, which may be used by device 102 and mobile computing devices 120, 122.

Device 102, mobile computing devices 120, 122 and ELD 101 may each include program logic comprising computer source code, scripting language code or interpreted language code that perform various functions of the disclosed embodiments. In one embodiment, the aforementioned program logic may comprise program module 607 in FIG. 6. It should be noted that although FIG. 1 shows only two mobile computing devices 120, 122, one ELD 101 and one device 102, the system of the disclosed embodiments supports any number of servers, locators and mobile computing devices connected via network 106. Also note that although device 102 is shown as a single and independent entity, in one embodiment, device 102 and its functionality can be realized in a centralized fashion in one computer system or in a distributed fashion wherein different elements are spread across several interconnected computer systems.

Environment 100 may be used when devices 120, 101 engage in buried asset detection, as well as quality control and quality assurance, activities that comprise reading, generating, and storing buried asset data and related quality information. Various types of data may be stored in the database 104 of device 102 (as well as data storage on devices 120, 122 and ELD 101) with relation to a buried asset that has been detected and located. For example, the database 104 (or devices 120, 122 and ELD 101) may store one or more records for each buried asset, and each record may include one or more buried asset data points. A buried asset data point may include a current time, a textual map address, and location data or position data, such as latitude and longitude coordinates, geographical coordinates, an altitude coordinate, or the like. A buried asset data point may also include depth measurement data, electromagnetic signal measurement data (such as electrical current measurement data, resistance measurement data, impedance measurement data, electrical signal magnitude measurement data, electrical signal frequency measurement data, electrical signal voltage measurement data, etc.), direction data and orientation data. Each record may include data for one buried asset data point.

A buried asset data point may also include a precision data value corresponding to any piece of information associated with a buried asset data point, such as the geographical coordinate or. A precision data value is a value that represents the quality or level of precision of a piece of information, such as a geographical coordinate. All sensors and devices that read physical quantities have a certain amount of measurement error or observational error. A precision data value represents the amount or magnitude of the measurement error or observational error of a sensor or device at one time. In one embodiment, a precision data value is a numerical value, such as a real number from 0 to 1.0 (with a variable number of decimal points) wherein zero represents perfect precision, 0.5 represents a precision that is 50% off from a true value, 0.75 represents a precision that is 75% off from a true value, etc. In another embodiment, a precision data value is an alphanumeric value (such as a word or other ASCII string) that corresponds (according to a lookup table or other correspondence table) to a predefined amount of precision. In another embodiment, a precision data value is any set of values that may be sorted according to ascending or descending value. Thus, in this embodiment, precision data values may have ascending and descending values.

In one embodiment, the precision data value is inversely proportional to the level of precision of quality of a piece of information, such as a geographical coordinate. Thus, when there is a large margin of error or a low confidence level in a piece of information, then the precision data value is high and the quality or level of precision of the information is low. Conversely, when there is a small margin of error or a high confidence level in a piece of information, then the precision data value is low and the quality or level of precision of the information is high.

With regard to geographical coordinates, HDOP, VDOP, PDOP, and TDOP values (Horizontal, Vertical, Positional and Time Dilution of Precision, respectively) are precision data values well known in the art for representing the quality or level of precision of a geographical coordinate. Also with regard to geographical coordinates, values representing the quality or level of precision of a geographical coordinate may rely on whether a differential correction technique (such as differential GPS) was used in calculating the coordinate. The Differential Global Positioning System (DGPS) is an enhancement to Global Positioning System that provides improved location accuracy. DGPS uses a network of fixed, ground-based reference stations to broadcast the difference between the positions indicated by the satellite systems and the known fixed positions. As such, if DGPS was used to calculate a geographical coordinate, then the precision data value of the coordinate may reflect that fact. For example, the precision data value may indicate higher accuracy if DGPS was used.

In one embodiment, Precise Point Positioning (PPP) is used to generate a precision data value representing the quality or level of precision of a geographical coordinate. PPP is a global navigation satellite system positioning method to calculate precise positions up to few centimeter level using a single receiver in a dynamic and global reference framework. The PPP method combines precise clocks and orbits calculated from a global network to calculate a precise position with a single receiver.

A buried asset data point may also include a precision data value corresponding to any piece of information associated with a buried asset data point, such as a current time, a textual map address, depth measurement data, electrical signal measurement data (such as electrical current measurement data, signal strength data, resistance measurement data, impedance measurement data, electrical signal magnitude measurement data, electrical signal frequency measurement data, electrical signal voltage measurement data, electromagnetic vector data, horizontal EM field (peak), vertical EM field (null), etc.), direction data (left or right indicators that direct the technician to the location of the buried asset), orientation data, and location data or position data, such as latitude and longitude coordinates, geographical coordinates, an altitude coordinate, or the like.

Database 104 may also include a plurality of locate performance records. A locate performance record comprises real time sensor and data fusion derived from multiple sensors and inputs that enable inertial motion capture, electromagnetic locate signal analysis, GNSS data, and mode configuration data, among other things. Database 104 may include one or more a lookup tables that define a correspondence between each one of a plurality of component values of a performance record and one of a plurality of performance measurements of a buried asset location procedure performed by a field technician. Said lookup tables may represent industry standards for buried asset location procedure and technique. I.e., said lookup tables may represent a benchmark against which a locate technician's performance can be compared. A performance measurement may be a graduating or continuous numerical scale, such as from 1 to 10, wherein 1 is considered low performance and 10 is considered excellent performance A performance measurement may also be a set of words, for example, wherein the word BAD is considered low performance and the word GOOD is considered excellent performance Note that in this description, any of the data described as stored in database 104 may also be stored in devices 120 and/or 101.

FIG. 1B is an illustration of a conventional ELD 190 in a disassembled state, showing the PCBA 150 being installed for retrofitting the conventional ELD 190, according to an example embodiment. The PCBA 150 may also be said to customize the conventional ELD with additional functionality, to outfit the conventional ELD with additional functionality, to modernize the conventional ELD to include additional functionality or to overhaul the conventional ELD to include additional functionality. A printed circuit board (PCB) mechanically supports and electrically connects electronic components using conductive tracks, pads and other features etched from copper sheets laminated onto a non-conductive substrate. Electrical components (e.g. capacitors, resistors or active devices) are generally soldered on the PCB. A PCB populated with said electronic components is referred to as a printed circuit assembly, a printed circuit board assembly (PCBA), a circuit card assembly, an expansion card or simply as a “card.” Since the claimed subject matter pertains to a PCBA that retrofits conventional ELDs with quality control and quality assurance processes, the claimed subject matter may be referred to as a retrofit card.

FIG. 1B shows that the PCBA 150 may be coupled to the existing electronic infrastructure of the conventional ELD 190. The conventional ELD 190 may be disassembled, for example, by removing a back cover or back plate 191 of the ELD, so as to gain access to its inner volume. The PCBA 150 may then be conductively coupled to the existing electronic infrastructure of the conventional ELD 190, and physically fastened to the body of the ELD. The PCBA 150 is described in greater detail below.

FIG. 1C is an illustration of the PCBA 150 for retrofitting the conventional ELD 190, showing the internal components of the PCBA, according to an example embodiment. FIG. 1C shows that the PCBA 150 includes a PCB 154 including a plurality of electrical components. The PCBA includes at least one orifice 152 in the PCB configured for fastening to the conventional ELD. The orifice 152 may also include a standoff that is used to mount the PCBA to existing mounting positions in the interior volume of the conventional ELD. A standoff may be a raised cylinder including a threaded interior, wherein a bolt is screwed into the standoff and extended through an orifice in the ELD, so as to attach or fasten the PCBA to the ELD. The PCBA also includes a communications bus 157 for transferring data and a power network 158 for distributing power within the PCBA and for pulling power from an external node into the PCBA. The communications bus is a communication system that transfers data between components inside the PCBA, or between the PCBA and external nodes. The communications bus includes all related hardware components (wire, optical fiber, etc.) and software, including communication protocols.

The PCBA also includes a data connector 156 for communicatively coupling the communications bus 157 with a communications bus on the conventional ELD. The data connector 156 may act as a serial port, which is a serial communication interface through which information transfers in or out one bit at a time. The data connector 156 may support an RS-232 standard 19,200 bps data connection. The PCBA also includes a power connector 159 configured for conductively coupling the power network 158 with a power network on the conventional ELD. In one embodiment, the data connector 156 and power connector 159 are merged into one connector, for example a single 12-pin connector.

The PCBA also includes a global navigation satellite system (GNSS) processor 153 communicatively coupled with the communications bus 157 and conductively coupled with the power network 158. The GNSS processor 153 is configured for calculating and transmitting a current global position of the device. The processor 153 may be one or more of any of the commercially available chips and modules for the GNSS, including receivers for GPS, GLONASS, Galileo, BeiDou and QZSS. The GNSS processor 153 produces a variety of information well known in the art, namely, a global position value, such as latitude and longitude coordinates.

The PCBA also includes a low-power radio frequency (RF) transmitter/receiver 155 communicatively coupled with the communications bus 157 and conductively coupled with the power network 158. The RF transmitter/receiver is configured for transmitting and receiving data over RF. The RF transmitter/receiver may be one or more of any of the commercially available chipsets and modules for exchanging data over short distances, such as a Bluetooth chipset. The PCBA also includes a processor 151 communicatively coupled with the communications bus 157 and conductively coupled with the power network 157. The functionality of processor 151 is described in greater detail below.

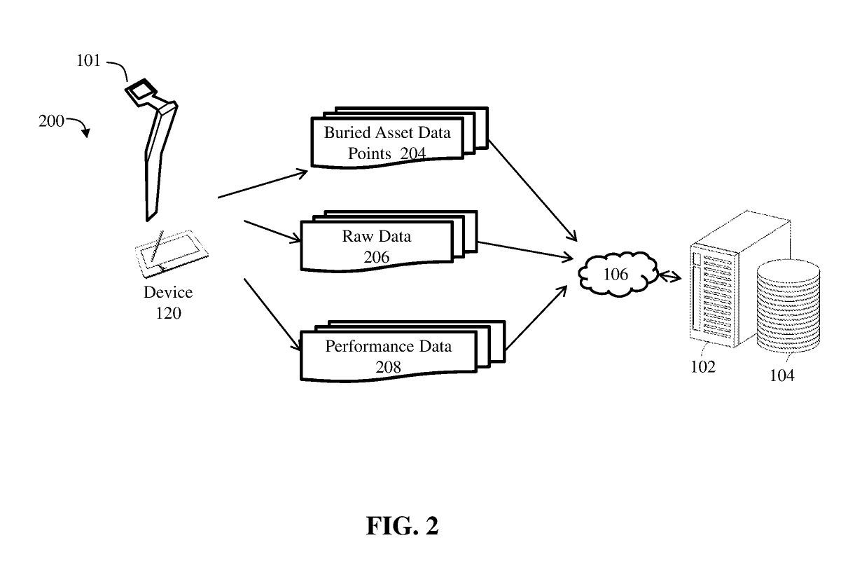

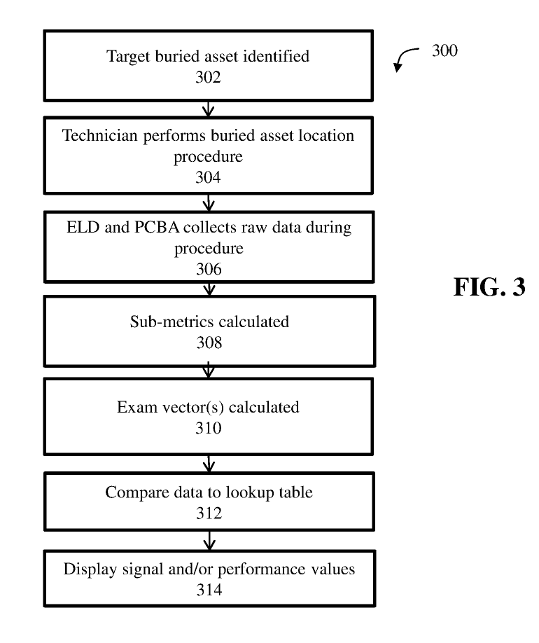

FIG. 3 is a flow chart showing the control flow of the process 300 for measuring quality of a buried asset location procedure for quality control and quality assurance, according to an example embodiment. Process 300 describes the steps that begin to occur when the locate technician 110 detects and identifies a particular target buried asset 130 that may be located within an area including multiple buried assets. The process 300 is described with reference to FIG. 2, which shows the general data flow 200 of the process 300.

Prior to the beginning of the process 300, it is assumed that stored in database 104 is one or more lookup tables, as described above.

Process 300 starts in earnest with step 302 wherein a target buried asset 130, which is the buried asset the technician 110 is seeking, is identified to the technician 110 and/or the server 102. In one embodiment, this step is accomplished when the device 102 receives a work ticket specifying that a buried asset locate procedure must be performed at a particular location for a particular buried asset identified by a unique identifier, type of buried asset, expected reading for buried asset, or the like. In another embodiment, this step is accomplished by the server 102 receiving a command from the technician 110, wherein the device 120 sends a unique identifier for the target buried asset 130 to the server 102 via network 106. Step 302 may be performed while the technician 110 is located on site in the vicinity of the target buried asset, while the technician is at work or headquarters, while the technician is at home, on the road, or at any other location. In another embodiment, step 302 may be performed automatically when the technician 110 arrives at the vicinity of the target buried asset, the device 120 sends its current geographical location to the device 102 and the device 102 determines which buried assets are located at said location. Note the ELD 101 referred to herein refers to a conventional ELD that has been retrofitted with the PCBA 150, as described herein.

In step 304, the technician 110 performs a buried asset location procedure using his ELD 101 (and optionally the device 120) and generates buried asset data and/or buried asset data points 204, which may be stored locally on devices 101 or 120 and also uploaded to the server 102 via network 106. The ELD 101 may utilize an antenna array to read raw analog signals 140 emanating from the target buried asset 130. Based on the data it has received and calculated, ELD 101 calculates one or more buried asset data points 204 for the target buried asset. Upon generating the buried asset data points, the technician may place physical markings on the ground corresponding to each point, such as a flag, a paint mark or a combination of the two. The device 102 receives the buried asset data and/or buried asset data points 204 via network 106 and creates records in the database 104 to hold said data.

In step 306, the PCBA 150 in the ELD 101 (and optionally the device 120) collects the following raw data 206 produced by the ELD 101 as a result of performance of the buried asset location procedure by the field technician 110: 1) motion data from an accelerometer and a gyroscope in the ELD 101, and wherein said motion data includes motion in three dimensions, and wherein said motion data is produced as a result of movement of the ELD 101 by the field technician during performance of the buried asset location procedure (may also be garnered from rotation or tilt sensor), 2) electromagnetic data from one or more electromagnetic sensors in the ELD 101, wherein said electromagnetic data includes current and depth measurements, as well as device gain and full scale deflection data, and wherein said electromagnetic data is produced as a result of movement of the ELD 101 by the field technician during performance of the buried asset location procedure, 3) a mode of the ELD 101, wherein the mode includes a frequency mode of the ELD 101, and wherein the mode is set by the field technician during performance of the buried asset location procedure, and 4) position data of the ELD 101 from a global navigation satellite system receiver in the ELD 101.

Motion data may include the detection and logging of various vectors in all degrees of motion, velocity and acceleration of the ELD 101. Electromagnetic data may include electrical current measurement data, resistance measurement data, impedance measurement data, electrical signal magnitude measurement data, electrical signal frequency measurement data, electrical signal voltage measurement data, etc. The electromagnetic data produced by the ELD may be displayed in the ELD, wherein motion data (leading up to the logging of the electromagnetic data) from the accelerometer and gyroscope in the ELD is stored, such that said motion data may be evaluated to determine proper performance and procedure of the buried asset location procedure leading up to the logging of the electromagnetic data.

A mode of the ELD may include any one of a variety of modes (that are well-known in the art) in which a locator device may be placed. With regard to mode of the ELD 101, each ELD 101 has various modes that the field technician selects depending on type of utility, type of environment, etc. These device mode selections include frequency selections to match transmitter selection, peak signal mode, null signal mode, peak and null signal modes simultaneously, line versus sonde/probe mode. Said device mode selections may define a locate device operating mode. Each ELD 101 may also collect electromagnetic (EM) signal response data, which indicates how the locator device is responding to the electromagnetic signals (140) it is detecting and processing, as well as signal strength, signal direction (left right of target), system gain control, phase (direction) of signal, measured depth, measured current, etc. The raw data collected in step 306 is then used at a later point to generate performance measurements that represent the technician's performance during said buried asset location procedure, according to industry standards.

Next, in step 308, the PCBA 150 in the ELD 101 calculates sub-metrics based on the raw data collected in step 306. In this step, the PCBA 150 in the ELD 101 calculates the following raw sub-metrics based on the data collected in step 306, and uses said sub-metrics as the component values of a first quantity vector:

a) an alignment of acceleration of the ELD with gravity, calculated as

$$mean ( \frac{a . g}{‖ a ‖ ‖ g ‖} ) ,$$

b) magnitude of non-gravity acceleration of the ELD, calculated as rms (∥a∥−∥g∥),

c) rotation of the ELD about its x-axis, calculated as rms (ωₓ),

d) rotation of the ELD about its y-axis, calculated as rms (ω_{y}),

e) rotation of the ELD about its z-axis, calculated as rms (ωₑ).

wherein a may be a vector that represents acceleration, g may be a vector that represents gravity, rms stands for root mean squared and mean stands for a statistical mean.

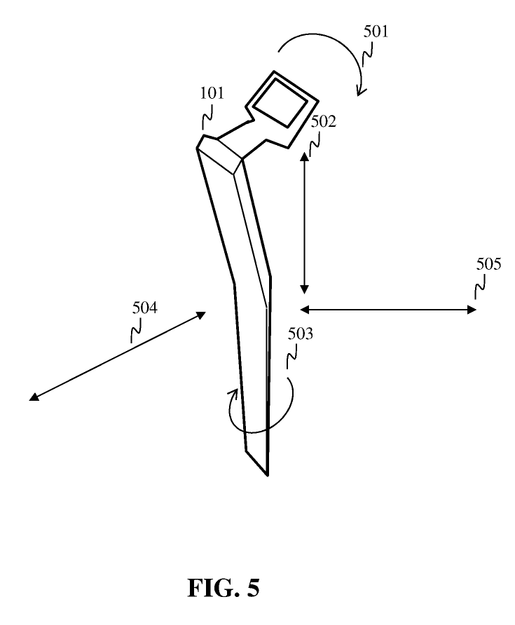

See FIG. 5 below for a description of the movement of the ELD in various degrees of freedom. Next, in step 310, the PCBA 150 in the ELD 101 calculates component values of a first exam vector based on the quantity vector, the first exam vector composed of the following components values:

a) a score based on whether the ELD is aligned with gravity, calculated based on

$$mean ( \frac{a . g}{‖ a ‖ ‖ g ‖} ) ,$$

b) a score based on magnitude of motion of the ELD, calculated based on rms (∥a∥−∥g∥),

c) a score based on magnitude of rotation of the ELD about x-axis, calculated based on rms (ωₓ),

d) a score based on magnitude of rotation of the ELD about y-axis, calculated based on rms (ω_{y}),

e) a score based on magnitude of rotation of the ELD about z-axis, calculated based on rms (ω_{z}),

f) a score based on whether rotation of the ELD about the z-axis is dominant calculated based on rms (ω_{z}), rms (ωₓ) and rms (ω_{y}),

wherein ω_{y} represents rotation about the y axis, ω_{z} represents rotation about the z axis and ωₓ represents rotation about the x axis. Each of ω_{y}, ω_{z} and ωₓ may be rotation vectors and each may further represent an array of data representing rotation about a specific axis. In one embodiment, a score may be a numerical value, such as the numbers 0, 1 or 2. In another embodiment, a score is based on whether the resulting value is within certain ranges. For example, if

rms (ωₓ) is calculated to be greater than 50 units per second, then a score of 2 is applied, if

rms (ωₓ) is calculated to be between 18 and 50 units per second, then a score of 1 is applied, and if rms (ωₓ) is calculated to be less than 18 units per second, then a score of 0 is applied. This paradigm may be applied to all factors a) through f) above.

In step 312, the PCBA 150 in the ELD 101 accesses the lookup table, and reads a performance measurement 208 that corresponds with each one of said plurality of component values of the first exam record, so as to read a plurality of performance measurements 208. The result of this step is that a plurality of performance measurements are read and stored.

Alternatively, in step 312, the PCBA 150 in the ELD 101 accesses the lookup table, and reads a performance measurement that corresponds with each one of said plurality of component values of the performance record of the field technician 110, so as to read a plurality of performance measurements.

In step 314, the ELD 101 executes a visual or audio signal, if one or more of said plurality of performance measurements 208 are below a given threshold, so as to notify the first field technician that performance of the buried asset location procedure by the first field technician is below said threshold. Also, the ELD 101 may display the plurality of performance measurements, which indicates performance of the buried asset location procedure and technique of the first field technician according to said industry standards embedded in the lookup table. In an optional final step, the ELD 101 uploads to server 102, via network 106, all of the data (including 204, 206, 208) it has collected and calculated in steps 304 through 312. Alternatively, the PCBA 150 on ELD 101 transmits via transmitter 155 to device 120 (or another third party node), all of the data (including 204, 206, 208) it has collected and calculated in steps 304 through 312.

The initial data collected in step 306 and the data calculated in steps 308-312 comprise the quality control aspect of the claimed subject matter. Quality control is a process by which entities review the quality of all factors involved in production by the field technicians. Part of said process includes automated inspection or review of the data collected in step 306 and the data calculated in steps 308-312 to determine whether said data meets industry standards.

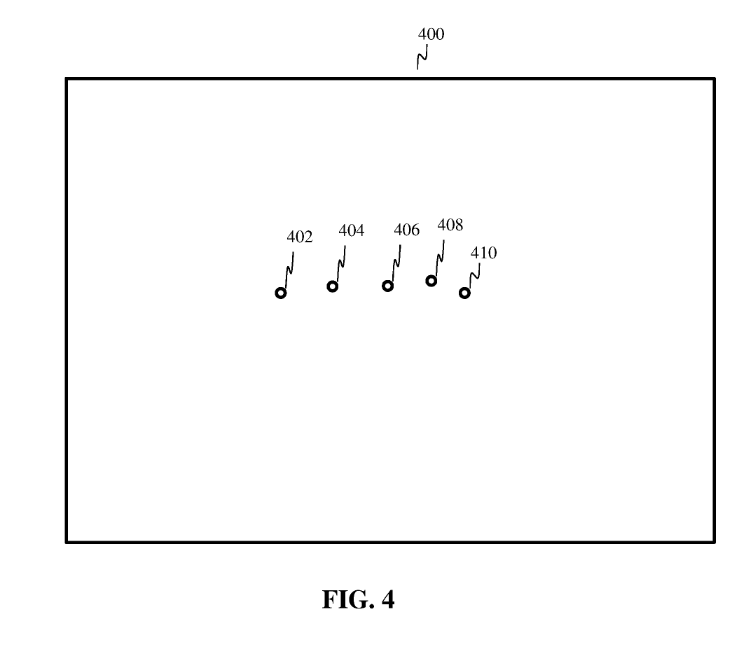

FIG. 4 is an illustration showing the process of logging buried asset data points, according to an example embodiment. FIG. 4 shows that buried asset data points 402, 404, 406, 408, 410 were logged in a geographical area represented by the two dimensional area 400.

FIG. 5 is an illustration showing movement of a locator device in various degrees of freedom, according to an example embodiment. Arrow 503 show rotation of the ELD 101 about the z-axis. Arrow 502 shows up and down movement of the ELD 101 along the z-axis. Arrow 504 shows movement of the ELD forward or backwards along the y-axis. Arrow 505 shows movement of the ELD to the sides along the x-axis. Arrow 501 shows tilting of the ELD.

FIG. 6 is a block diagram of a system including an example computing device 600 and other computing devices. Consistent with the embodiments described herein, the aforementioned actions performed by device 102, devices 120, 122, PCBA 150, and ELD 101 may be implemented in a computing device, such as the computing device 600 of FIG. 6. Any suitable combination of hardware, software, or firmware may be used to implement the computing device 600. The aforementioned system, device, and processors are examples and other systems, devices, and processors may comprise the aforementioned computing device. Furthermore, computing device 600 may comprise an operating environment for system 100 and process 300, as described above. Process 300 may operate in other environments and are not limited to computing device 600.

With reference to FIG. 6, a system consistent with an embodiment may include a plurality of computing devices, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination or memory. System memory 604 may include operating system 605, and one or more programming modules 606. Operating system 605, for example, may be suitable for controlling computing device 600's operation. In one embodiment, programming modules 606 may include, for example, a program module 607 for executing the actions of device 102, devices 120, 122, PCBA 150, and ELD 101. Furthermore, embodiments may be practiced in conjunction with a graphics library, other operating systems, or any other application program and is not limited to any particular application or system. This basic configuration is illustrated in FIG. 6 by those components within a dashed line 620.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a camera, a touch input device, etc. Output device(s) 614 such as a display, speakers, a printer, etc. may also be included. Computing device 600 may also include a vibration device capable of initiating a vibration in the device on command, such as a mechanical vibrator or a vibrating alert motor. The aforementioned devices are only examples, and other devices may be added or substituted.

Computing device 600 may also contain a network connection device 615 that may allow device 600 to communicate with other computing devices 618, such as over a network in a distributed computing environment, for example, an intranet or the Internet. Device 615 may be a wired or wireless network interface controller, a network interface card, a network interface device, a network adapter or a LAN adapter. Device 615 allows for a communication connection 616 for communicating with other computing devices 618. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 604, including operating system 605. While executing on processing unit 602, programming modules 606 (e.g. program module 607) may perform processes including, for example, one or more of the stages of the processes 200-500 as described above. The aforementioned processes are examples, and processing unit 602 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A printed circuit card assembly (PCBA) configured for retrofitting a conventional electromagnetic locator device (ELD) with quality control and quality assurance processes, the PCBA comprising:
a printed circuit board (PCB) including a plurality of electrical components;
at least one orifice in the PCB configured for fastening to the conventional ELD;
a first communications bus for transferring data;
a first power network for distributing power;
a data and power connector configured for: 1) communicatively coupling the first communications bus with a communications bus on the conventional ELD, and 2) conductively coupling the first power network with a power network on the conventional ELD;
a global navigation satellite system (GNSS) processor communicatively coupled with the first communications bus and conductively coupled with the first power network, the GNSS processor configured for calculating a current global position;
a low-power radio frequency (RF) transmitter/receiver communicatively coupled with the first communications bus and conductively coupled with the first power network, the RF transmitter/receiver configured for transmitting and receiving data over RF;
a processor communicatively coupled with the first communications bus and conductively coupled with the first power network, the processor configured for:
a) storing a lookup table that defines a correspondence between each one of a plurality of component values and one of a plurality of performance measurements of a buried asset location procedure performed by a field technician;
b) reading from the conventional ELD via the data and power connector, in real time, the following raw data produced by the conventional ELD as a result of performance of a buried asset location procedure by a first field technician:
1) motion data from an accelerometer and a gyroscope in the conventional ELD, wherein said motion data is produced as a result of movement of the conventional ELD by the field technician during performance of the buried asset location procedure;
2) electromagnetic data from one or more electromagnetic sensors in the conventional ELD, wherein said electromagnetic data is produced as a result of movement of the conventional ELD by the field technician during performance of the buried asset location procedure; and
3) an operating mode of the conventional ELD, wherein the operating mode is set by the field technician during performance of the buried asset location procedure;
c) calculating component values of a performance record based on the raw data produced by the conventional ELD as a result of performance of the buried asset location procedure by the first field technician and populating the performance record with said component values;
d) accessing the lookup table, and reading a performance measurement that corresponds with each one of said plurality of component values of the performance record, so as to read a plurality of performance measurements; and
e) transmitting, via the RF transmitter/receiver, the performance record that was calculated and the performance measurement that corresponds with each one of said plurality of component values of the performance record.

2. The PCBA of claim 1, wherein the processor is further configured for:
f) executing a visual or audio signal on the conventional ELD, if one or more of said plurality of performance measurements are below a given threshold, so as to notify the first field technician that performance of the buried asset location procedure by the first field technician is below said threshold.

3. The PCBA of claim 2, wherein the step of calculating component values of a performance record based on the raw data produced by the conventional ELD further comprises:
calculating the following component values: a) an alignment of acceleration of the conventional ELD with gravity, b) magnitude of non-gravity acceleration of the conventional ELD, c) rotation of the conventional ELD about its x-axis, d) rotation of the conventional ELD about its y-axis, e) rotation of the conventional ELD about its z-axis.

4. The PCBA of claim 1, wherein the processor is further configured for:
calculating component values of a first exam vector based on the raw data, the first exam vector composed of the following components values: a) a score based on whether the conventional ELD is aligned with gravity, b) a score based on magnitude of motion of the conventional ELD, c) a score based on magnitude of rotation of the conventional ELD about x-axis, d) a score based on magnitude of rotation of the conventional ELD about y-axis, e) a score based on magnitude of rotation of the conventional ELD about z-axis, f) a score based on whether rotation of the conventional ELD about the z-axis is dominant.

5. The PCBA of claim 2, wherein the step of comparing the performance record further comprises:
comparing the first exam vector with a plurality of exam vector records so as to find a matching exam vector record with component values that match the component values of the first exam vector.

6. A system for customizing a conventional electromagnetic locator device (ELD) with quality control and quality assurance processes, the system comprising:
A) a conventional ELD comprising a processor configured for reading, in real time, the following raw data produced by the ELD as a result of performance of a buried asset location procedure by a field technician:
1) motion data from an accelerometer and a gyroscope in the ELD, wherein said motion data is produced as a result of movement of the ELD by the field technician during performance of the buried asset location procedure;
2) electromagnetic data from one or more electromagnetic sensors in the ELD, wherein said electromagnetic data is produced as a result of movement of the ELD by the field technician during performance of the buried asset location procedure;
3) a mode of the ELD, wherein the mode is set by the field technician during performance of the buried asset location procedure;
B) a printed circuit card assembly (PCBA) configured for retrofitting the ELD with quality control and quality assurance processes, the PCBA comprising:
a printed circuit board (PCB) including a plurality of electrical components;
at least one orifice in the PCB configured for fastening to the conventional ELD;
a first communications bus for transferring data;
a first power network for distributing power;
a data and power connector configured for: 1) communicatively coupling the first communications bus with a communications bus on the conventional ELD, and 2) conductively coupling the first power network with a power network on the conventional ELD;
a global navigation satellite system (GNSS) processor communicatively coupled with the first communications bus and conductively coupled with the first power network, the GNSS processor configured for calculating a current global position;
a low-power radio frequency (RF) transmitter/receiver communicatively coupled with the first communications bus and conductively coupled with the first power network, the RF transmitter/receiver configured for transmitting and receiving data over RF;
a processor communicatively coupled with the first communications bus and conductively coupled with the first power network, the processor configured for:
a) storing a lookup table that defines a correspondence between each one of a plurality of component values and one of a plurality of performance measurements of a buried asset location procedure performed by a field technician;
b) reading from the conventional ELD via the data and power connector, in real time, the following raw data produced by the conventional ELD as a result of performance of a buried asset location procedure by a first field technician: the motion data, the electromagnetic data, and the mode of the ELD;
c) calculating component values of a performance record based on the raw data produced by the conventional ELD as a result of performance of the buried asset location procedure by the first field technician and populating the performance record with said component values;
d) accessing the lookup table, and reading a performance measurement that corresponds with each one of said plurality of component values of the performance record, so as to read a plurality of performance measurements; and
e) transmitting, via the RF transmitter/receiver, the performance record that was calculated and the performance measurement that corresponds with each one of said plurality of component values of the performance record.

7. The system of claim 6, wherein the processor is further configured for:
f) executing a visual or audio signal on the conventional ELD, if one or more of said plurality of performance measurements are below a given threshold, so as to notify the first field technician that performance of the buried asset location procedure by the first field technician is below said threshold.

8. The system of claim 7, wherein the step of calculating component values of a performance record based on the raw data produced by the conventional ELD further comprises:
calculating the following component values: a) an alignment of acceleration of the conventional ELD with gravity, b) magnitude of non-gravity acceleration of the conventional ELD, c) rotation of the conventional ELD about its x-axis, d) rotation of the conventional ELD about its y-axis, e) rotation of the conventional ELD about its z-axis.

9. The system of claim 6, wherein the processor is further configured for:
calculating component values of a first exam vector based on the raw data, the first exam vector composed of the following components values: a) a score based on whether the conventional ELD is aligned with gravity, b) a score based on magnitude of motion of the conventional ELD, c) a score based on magnitude of rotation of the conventional ELD about x-axis, d) a score based on magnitude of rotation of the conventional ELD about y-axis, e) a score based on magnitude of rotation of the conventional ELD about z-axis, f) a score based on whether rotation of the conventional ELD about the z-axis is dominant.

10. The system of claim 7, wherein the step of comparing the performance record further comprises:
comparing the first exam vector with a plurality of exam vector records so as to find a matching exam vector record with component values that match the component values of the first exam vector.

20. The device of claim 15, further comprising:
wherein the electromagnetic data produced by the ELD includes depth and current data, wherein said depth and current data are displayed in the ELD, and wherein motion data from the accelerometer and gyroscope in the ELD is stored, such that said motion data may be evaluated to determine performance of the buried asset location procedure.
